(19) United States
(12) Patent Application Publication
(10) Pub. No.: US 2023/0241933 A1
(43) Pub. Date: Aug. 3, 2023

(54) VEHICLE SENSOR LEARNING USING A LOW POWER WAKE-UP RECEIVER

(71) Applicant: SENSATA TECHNOLOGIES, INC., ATTLEBORO, MA (US)

(72) Inventors: SAMUEL K. STRAHAN, BALLYMENA (GB); MARK DUFFY, ANTRIM (GB); SAMUEL D. HOUSTON, ANTRIM (GB)

(21) Appl. No.: 17/926,588

(22) PCT Filed: Jun. 8, 2020
(86) PCT No.: PCT/US2020/036597

§ 371 Date: Nov. 19, 2022

(51) Int. Cl. B60C 23/04

(52) U.S. Cl. CPC B60C 23/0454; B60C 23/0479; B60C 23/0427; B60C 23/0461; B60C 23/0472

(57) ABSTRACT

Systems and methods for vehicle sensor learning using a low power wake-up receiver is disclosed. In a particular embodiment, a tire monitoring that comprises a low power receiver and a transceiver receives, at the low power receiver, a radio frequency (RF) activation signal from a remote device, transitions to a wake state in response to receiving the activation signal, and transmits, via the transceiver, an RF response signal including an identification code to the remote device. The remote device, such as a handheld activation tool or an activation station in an assembly line, transmits the activation signal, receives the response signal, and associates the identification code of tire monitoring sensor with a location on the vehicle. The identification code and location may be provided to the vehicle control system.

### BACKGROUND

A tire pressure monitoring system (TPMS) monitors tire pressure and/or tire temperature of the tires of a vehicle. A TPMS typically includes a plurality of wheel units (a “TPMS sensor”) and a remote monitoring system. A TPMS sensor measures the relevant characteristic(s) of the tire and transmits corresponding information to the remote monitoring system. Each TPMS sensor has a unique TPMS sensor identification code (ID) associated with it. When a vehicle control system (VCS) is able to associate each TPMS sensor ID with a wheel of the vehicle, then the vehicle original equipment manufacturer (OEM) can implement a “pressure by position” indication on the dashboard or vehicle display system.

When the vehicles are being built in the OEM production locations, TPMS sensors are typical taken from a box and installed on the tires or wheels. In some cases, this process can take place in a tire and rim assembly facility. When the wheels are fitted to the vehicle, the VCS is not initially aware of which TPMS sensor ID is associated with which wheel's TPMS sensor. In order for the vehicle to leave the OEM assembly plant tested, it is important to ensure that the TPMS function is operating correctly. In order to ensure operation in a timely manner, it is advantageous to have the each TPMS sensor ID programmed into the VCS.

Traditionally, in OEM vehicle production plants, the TPMS sensor ID is extracted from each TPMS sensor using a low frequency (LF) system typically operating at a frequency of 125 kHz. This frequency has the benefit of being very short range and minimizes the chances of activating more than one sensor on the vehicle at any one time. Often, an LF tool is used to activate each TPMS sensor to broadcast its TPMS sensor ID. As each TPMS sensor transmits its TPMS sensor ID, the LF tool captures the TPMS sensor ID associated with the transmitting wheel via an LF receiver in the tool. The captured TPMS sensor ID codes and their associated wheel locations can then be programmed into the appropriate module of the VCS at a point further down the production line.

In relation to the TPMS wheel sensor, the requirement to be able to activate the TPMS sensor via an LF signal requires circuitry to enable the sensor to react and respond accordingly. This circuitry typically comprises an LF coil with associated tuning capacitors, an LF amplifier circuitry (typically integrated into an application specific integrated circuit (ASIC) or similar device), and a decoding circuit (also typically integrated into an ASIC). As TPMS sensors evolve, the electronic portion of the device is becoming smaller and smaller. The constraints of the printed circuit board (PCB), upon which the LF coil is disposed, in the TPMS sensors are such that the size of the LF coil required to meet the LF sensitivities is consuming a large portion of the PCB real estate. The electronic designs are now coming to a point where the LF coil size is hampering further size reductions.

### SUMMARY

Embodiments in accordance with the present disclosure are directed to using a low power wake-up receiver for vehicle sensor learning. Embodiments in accordance with the present disclosure eliminate the large LF coil used in typical tire sensors, to facilitate size and cost reduction of the tire monitoring sensor. The elimination of the LF coil also allows for the integration of all electronic components within one module, thus eliminating the need for a PCB and a PCB sub assembly. In embodiments in accordance with the present disclosure, the need for the large LF coil is eliminated by replacing it with a low power receiver that operates at the same frequency as other transceivers of a tire monitoring system (e.g., a TPMS). In a particular embodiment, the low power receiver operates in the 2.4 GHz band used by Bluetooth Low Energy (BLE) transceivers in the TPMS and other vehicle and tire monitoring systems. Rather than keeping the BLE transceiver “on” during manufacture and assembly so that the BLE may receive the wake-up signal, the LPR may remain on during manufacture and assembly of the vehicle such that the low power receiver receives the wake-up signal and causes the tire monitoring sensor to broadcast the sensor ID, such that the activation tool may receive the sensor ID and associate it with the sensor/tire location.

In a particular embodiment of the present disclosure, vehicle sensor learning using a low power wake-up receiver includes a tire monitoring sensor entering a standby state. In this embodiment, a low power receiver of the tire monitoring sensor receives a radio frequency (RF) activation signal transmitted by a remote device. In response to receiving the activation signal, the tire monitoring sensor transitions to a wake state and a transceiver of the tire monitoring sensor transmits an RF response signal including an identification code to the remote device. In this embodiment, the RF activation signal and the RF response signal are transmitted in the same RF band.

In another embodiment, vehicle sensor learning using a low power wake-up receiver in accordance with the present disclosure includes a device transmitting a radio frequency (RF) activation signal to a low power receiver of a tire monitoring sensor and receiving an RF response signal from a transceiver of the tire monitoring sensor. In this embodiment, the response signal includes an identification code for the tire monitoring sensor. The device associates the identification code with a tire location on the vehicle and provides the identification code and associated tire location to a vehicle control system.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A sets forth an isometric diagram of a system for vehicle sensor learning using a low power wake-up receiver in accordance with the present disclosure;

FIG. 1B sets forth a top view of the system of FIG. 1A;

FIG. 2 illustrates a block diagram of an exemplary tire monitoring sensor in accordance with the present disclosure;

FIG. 3 illustrates another block diagram of an exemplary tire monitoring sensor in accordance with the present disclosure;

FIG. 4 illustrates a block diagram of an exemplary vehicle control system in accordance with the present disclosure;

FIG. 5 sets forth a flowchart of an example method for vehicle sensor learning using a low power wake-up receiver in accordance with the present disclosure;

FIG. 6 sets forth a flowchart of another example method for vehicle sensor learning using a low power wake-up receiver in accordance with the present disclosure;

FIG. 7 sets forth a flowchart of another example method for vehicle sensor learning using a low power wake-up receiver in accordance with the present disclosure; and

FIG. 8 sets forth a flowchart of another example method for vehicle sensor learning using a low power wake-up receiver in accordance with the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

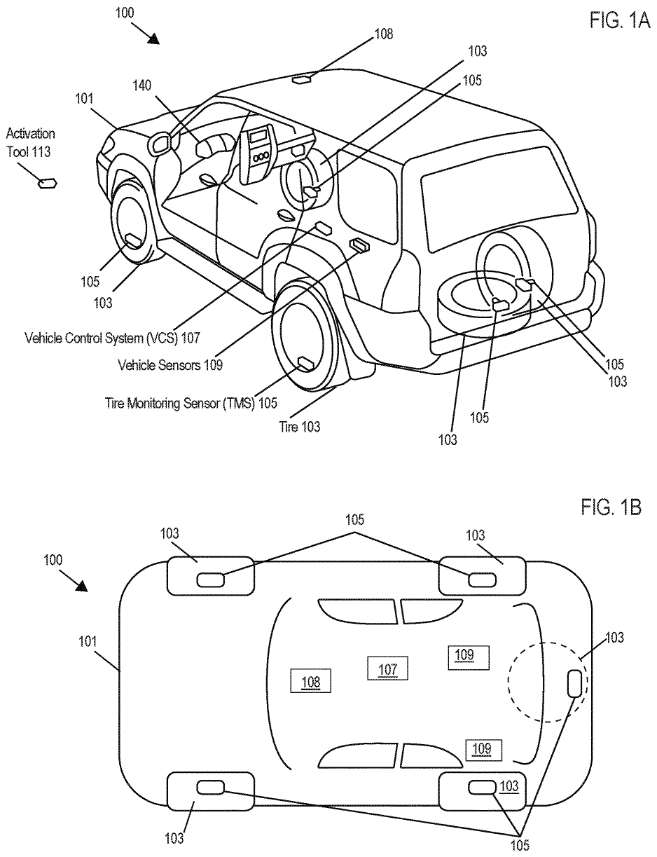

Exemplary methods, apparatuses, and computer program products for vehicle sensor learning using a low power wake-up receiver in accordance with the present disclosure are described with reference to the accompanying drawings, beginning with FIG. 1A. FIG. 1A sets forth an isometric diagram of a system (100) for vehicle sensor learning using a low power wake-up receiver in accordance with the present disclosure. FIG. 1B sets forth a top view of the system of FIG. 1A. The system (100) of FIG. 1A and FIG. 1B includes a vehicle (101) equipped with tires (103) that include tire monitoring sensors (105) (hereafter, “TMS”). A tire monitoring sensor may be any type of sensor that is configured for monitoring parameters associated with a tire. Examples of a tire monitoring sensor include but are not limited to a tire mounted sensor, a valve-stem mounted sensor, a wheel mounted sensor, and other sensors as will occur to those of skill in the art.

The vehicle (101) further includes a vehicle control system (VCS) (107) that controls various components and systems within a vehicle. In a particular embodiment, the VCS (107) includes one or more electronic control units (ECUs) that are configured to control one or more vehicle subsystems. Commonly referred to as the vehicle's “computers”, an ECU may be a central control unit or may refer collectively to one or more vehicle subsystem control units, such as an Engine Control Module (ECM), a Powertrain Control Module (PCM), a Transmission Control Module (TCM), a Central Timing Module (CTM), a General Electronic Module (GEM), or a Suspension Control Module (SCM). In an embodiment according to the present disclosure, the VCS (107) includes a BCM that includes an Antilock Braking System (ABS) and an Electronic Stability Program (ESP). Alternatively, the VCS (107) may comprise a Telematics Control Unit (TCU) independent of vehicle-based sensors (e.g., an aftermarket system). The vehicle (101) also includes a dashboard display screen (140) for displaying messages from components of the vehicle. For example, the VCS (107) may send a ‘low tire pressure’ message to a component connected to the dashboard display screen (140). In this example, in response to receiving the ‘low tire pressure’ message, the component may turn on a ‘low tire pressure’ indicator that is displayed on the dashboard display screen (140). As another example, the VCS (107) may send information to the component for displaying the pressure of a particular tire. In this example, the pressure of each tire may be displayed on the dashboard display screen (140).

Each vehicle may include sensors (109) used to measure and communicate vehicle operating conditions. For example, the ABS may include wheel speed sensors on the wheelbase used to measure wheel speed. The sensors (109) may include yaw rate sensors configured to measure the yaw-induced acceleration of the vehicle when the vehicle is maneuvering a curve. Readings from such sensors (109) may be provided to the VCS (107), which may provide parameters based on these readings to the TMS (105).

The vehicle (101) may further include a transceiver (108) communicatively coupled to the VCS (107) for cellular terrestrial communication, satellite communication, or both.

In a particular embodiment, the tire monitoring sensor (105) includes a tire pressure monitoring system (TPMS) sensor. The tire monitoring sensor (105) measures operational characteristics of the tire, such as tire pressure, tire temperature, and motion characteristics, and communicates the collected data to a vehicle control system (VCS) (107).

The tire monitoring sensor (105) is equipped with a wireless transceiver for bidirectional wireless communication with the VCS (107), as will be described in more detail below. The VCS (107) is similarly equipped with a wireless transceiver for bidirectional wireless communication with the tire monitoring sensor (105), as will be described in more detail below. The bidirectional wireless communication may be realized by low power communication technology such as Bluetooth Low Energy, Bluetooth Smart, or other low power bidirectional communication technology that is intended to conserve energy consumed. Alternatively, the tire monitoring sensor (105) may include a unidirectional transmitter configured to transmit signals to the VCS (107).

The tire monitoring sensor (105) is identifiable by a unique identification code, also referred to herein as a sensor identifier (ID). For example, the sensor ID may be a Media Access Control (MAC) address, Bluetooth address, device address, or other static address of the tire monitoring sensor (105) or a communication component thereof. As another example, the sensor ID may be a serial number or other unique identifier. The sensor ID may be included in each transmission frame, or may be associated with a particular transmission channel. However, when the tire (103) including the monitor device (105) is installed on the vehicle (101) (e.g., in a vehicle assembly line or at a dealership), the VCS (107) is unable to discern which sensor ID is associated with which tire location on the vehicle. A tool (113), such as a handheld device or assembly line station, may be used to collect the sensor ID from the tire monitoring sensor (105) and associate the sensor ID with a tire location on the vehicle. The sensor ID and tire location may then be provided to the VCS (107). Conventionally, a 125 kHz exciter signal is used to activate a low frequency coil in a tire monitoring sensor to induce the tire monitoring sensor to broadcast a sensor ID using an ultra-high frequency (UHF) radio frequency (RF) signal that is received by the tool. However, embodiments in accordance with the present disclosure provide an improved mechanism for obtaining the sensor ID from the tire monitoring sensor, as will be explained in detail below.

The arrangement of devices making up the exemplary system illustrated in FIG. 1A and FIG. 1B are for explanation, not for limitation. Data processing systems useful according to various embodiments of the present disclosure may include additional devices and networks, not shown in FIG. 1A and FIG. 1B, as will occur to those of skill in the art. Networks in such data processing systems may support many data communications protocols, including for example TCP (Transmission Control Protocol), IP (Internet Protocol), Bluetooth protocol, Near Field Communication, Controller Area Network (CAN) protocol, Local Interconnect Network (LIN) protocol, FlexRay protocol, and others as will occur to those of skill in the art. Various embodiments of the present disclosure may be implemented on a variety of hardware platforms in addition to those illustrated in FIGS. 1A and 1B.

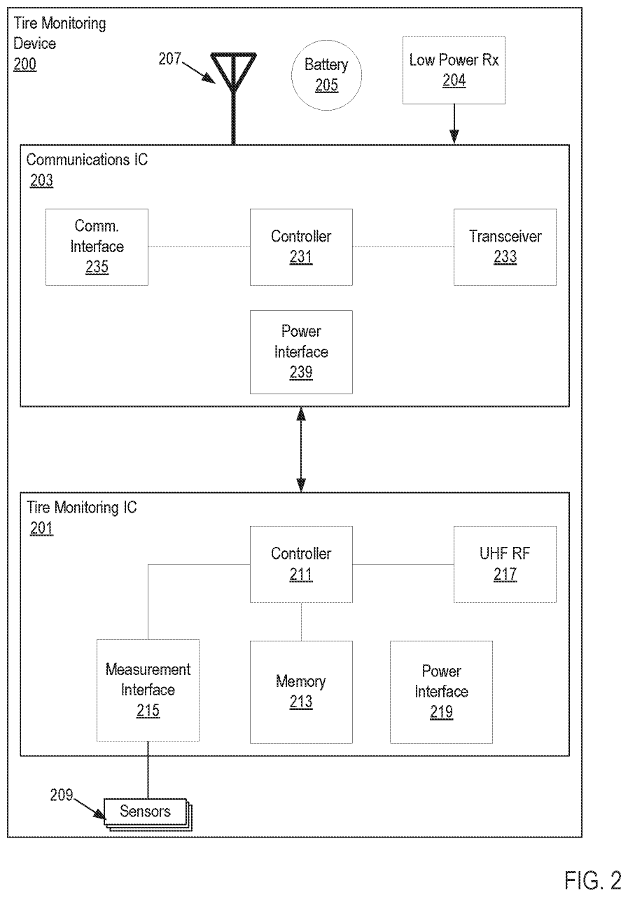

For further explanation, FIG. 2 sets forth a diagram of an example implementation of a tire monitoring sensor (200) for vehicle sensor learning using a low power wake-up receiver according to embodiments of the present disclosure. The example tire monitoring sensor (200) of FIG. 2 includes a tire monitoring integrated circuit (IC) (201), a communication IC (203), a low power receiver (204), a battery (205), an antenna (207), and one or more sensors (209) such as a pressure sensor (e.g. a piezo resistive transducer or a piezoelectric or capacitance based pressure sensor for measuring air pressure in a respective tire), a temperature sensor, and a motion sensor (e.g., an accelerometer responsive to acceleration and/or changes in acceleration experienced during rotation of a respective tire).

The tire monitoring IC (201) includes a measurement controller (211), which may comprise a suitably programmed processor, for example a dedicated microprocessor or a microcontroller, or other programmable processing device. Standard components such as random-access memory (RAM), an analog-to-digital converter (ADC), an input/output (I/O) interface, a clock, and a central microprocessor (all not shown) may be provided, the components typically being integrated onto a single chip. Alternatively, or additionally, a custom microcontroller such as an Application Specific Integrated Circuit (ASIC), a digital signal processor (DSP), a programmable logic array (PLA) such as a field programmable gate array (FPGA), or other data computation unit in accordance with the present disclosure may be used. The measurement controller (211) may be configured to collect sensor readings related to tire operating conditions from the sensors (209).

The tire monitoring IC (201) also includes a measurement interface (215). The sensors (209) are connected to the measurement interface (215) for measuring characteristics of the tire using signals received from the sensors (209) and for providing corresponding information to the controller (211). The measurement interface (215) may comprise hardware (i.e., electronic circuitry) for performing measurement tasks, including but not limited to at least one amplifier, at least one filter and, and an ADC (all not shown) for measuring values such as tire pressure, temperature, and acceleration. The tire monitoring IC (201) may also include a memory (213). The sensor readings and data collected from the sensors (209) may be stored in the memory (213). The memory (213) may be a non-volatile memory such as flash memory. A unique identifier that may be used as a sensor ID may also be stored in the memory (213) or programmed into the controller (211).

The tire monitoring IC (201) may also include a power interface (219) for supplying power received from the battery (205) to the various components of the tire monitoring IC (201). In some embodiments, the tire monitoring IC (201) may also include a UHF RF transmitter (217) used for unidirectional communication to a corresponding receiver of the VCS. In some embodiments, the transmitter (217) may be used for transmitting tire measurements to the VCS using a 315 MHz or 433 MHz signal. The UHF RF transmitter may also be used to transmit the sensor ID, for example, in response to receiving a wake-up signal via the low power receiver (204).

The communications IC (203) includes a communications controller (231), which may comprise a suitably programmed processor, for example a dedicated microprocessor or a microcontroller, or other programmable processing device. Standard components such as random-access memory (RAM), an analog-to-digital converter (ADC), an input/output (I/O) interface, a clock, and a central microprocessor (all not shown) may be provided, the components typically being integrated onto a single chip. Alternatively or additionally, a custom microcontroller such as an Application Specific Integrated Circuit (ASIC), a digital signal processor (DSP), a programmable logic array (PLA) such as a field programmable gate array (FPGA), or other data computation unit in accordance with the present disclosure may be used. The communications controller (231) may be configured to receive tire parameters (e.g., tire pressure) collected by the tire monitoring IC (201) and transmit the tire parameters to the VCS. The communications controller (231) may also be configured to advertise a sensor ID to remote device such as an activation tool or activation station, as will be described in greater detail below.

The communications IC (203) also includes a transceiver (233) coupled to the controller (233). The transceiver (233) may be configured for bidirectional wireless communication. For example, once the transceiver is configured for communication with the VCS, the transceiver may be used to transmit tire parameters (e.g., tire pressure data, tire temperature data, accelerometric data) to the VCS and receive vehicle parameters and configuration parameters from the VCS. The transceiver (233) may be configured to communicate a sensor ID to a remote device such as an activation tool or activation station in an assembly line. The transceiver (233) may be configured for operation within a particular RF band, such as the Industrial, Scientific and Medical (ISM) 2.4 GHz band with a frequency range of 2.4 GHz to 2.5 GHz that includes an unlicensed portion of the RF spectrum. In a particular embodiment, the transceiver (233) is a Bluetooth protocol transceiver, such as a Bluetooth Low Energy transceiver or a Bluetooth Smart transceiver, operating between 2.4 GHz and 2.4835 GHz. In other embodiments, the transceiver (233) may be other types of low power radio frequency communication technology that is intended to conserve energy consumed in the tire monitoring sensor.

The communications IC (203) may also include a communications interface (235) for organizing data according to communications protocols for transmitting and receiving data via the transceiver (235). For example, the communications interface (235) may encapsulate data in packets. The communications IC (203) may also include a power interface (239) for supplying power received from the battery (205) to the various components of the communications IC (203).

The low power receiver (204) is an RF receiver that may be configured to receive an activation signal (also referred to as a wake-up signal) from a remote device such as a handheld activation tool, vehicle-mounted activation tool, or an activation station in an assembly line. The low power receiver (204) effectively replaces the LF system used by conventional tire monitoring sensors to receive an activation signal. The removal of the large LF coil reduces the size of electronic components used in the tire monitoring sensor (200). In some implementations, it is contemplated that the tire monitoring sensor (200) may be constructed with a minimal printed circuit board (PCB) footprint, particularly because the LF system is functionally replaced by the low power receiver (204). The low power receiver (204) is a low power device in that it draws less than 1 μA of current. In a particular embodiment, the low power receiver (204) draws less 200 nA of current. It will be appreciated by those of skill in the art that the power consumed by the low power receiver (204) is several orders of magnitude lower than the power consumed by the transceiver (233), even if the transceiver (233) is in a receive-only state, low rate duty cycle state, or other dormant state.

The low power receiver (204) may be configured for communication within the same RF band as the transceiver (233) (i.e., the ISM 2.4 GHz band with a frequency range of 2.4 GHz to 2.5 GHz). As such, remote devices, such as the activation tool or the activation station in an assembly line, may communicate an activation signal to the low power receiver (204) using the same transceiver used by the remote device to communicate with other sensors and devices (e.g., other Bluetooth protocol sensors). As such, a separate activation tool, such as an LF coil exciter, is not required to activate the tire monitoring sensor (200).

The battery (205) may provide power to respective power interfaces (219, 239) of the tire monitoring IC (201) and communications IC (203), as well as the low power receiver (204) and other components of the tire monitoring sensor (200). However, it also contemplated that other power sources may be used (e.g., thermoelectric or piezoelectric generators, electromagnetic induction device, and/or other energy harvesters) instead of or in addition to the battery (205).

The antenna (207) may be used by the tire monitoring sensor (200) to transmit and receive RF signals. The antenna (207) may be coupled to the transceiver (233) for transmitting and receiving RF signals. The antenna (207) may also couple to the low power receiver (204) for receiving an RF activation signal. It is also contemplated that the low power receiver (204) may include its own dedicated antenna (not shown).

In a particular embodiment, the tire monitoring sensor (200) may be installed on the vehicle at a vehicle dealership, a tire dealership, a repair shop, or a vehicle OEM assembly line. At the time of installation, the tire monitoring sensor may be in a standby state, in that the low power receiver (204) receives power, but the transceiver (233) and other components do not receive power. Power may be provided to the low power receiver (204) continuously or cycled at a particular interval. Prior to installation, the tire monitoring sensor (200) may be received in an OFF state such that no component receives power, and installation personnel may turn the tire monitoring sensor (200) to an ON state such that the low power receiver (204) begins receiving power. Upon installation, an activation tool such as a handheld device or assembly line activation station may transmit an activation signal to the tire monitoring sensor (200). The activation signal may be transmitted with a frequency within the 2.4 GHz band (i.e., 2.4 GHz to 2.5 GHz). The activation signal may be received by the low power receiver (204), which may provide a wake signal to the communications IC (203). The communications IC (203), in turn, may provide a wake signal to the tire monitoring IC (201), and also transmit a response signal encoding a sensor ID to the activation tool via the transceiver (233). The response signal may also be transmitted using the 2.4 GHz band. As such, the activation tool may transmit the activation signal and receive the response signal using a transceiver configured for communication within the 2.4 GHz band (e.g., a Bluetooth transceiver). The activation tool may then associate the sensor ID with a tire location on the vehicle, and subsequently provide sensor ID and tire location to the VCS (directly or indirectly).

In FIG. 2, the low power receiver (204) is illustrated as coupled to the communication IC (203). However, in another embodiment, the low power receiver (204) may be coupled to the tire monitoring IC (201), such that the tire monitoring IC (201) detects the wake-up signal from the low power receiver (204), and in turn provides a wake-up signal to the communications IC (203). In yet another embodiment, the low power receiver (204) may be integrated in the communications IC (203).

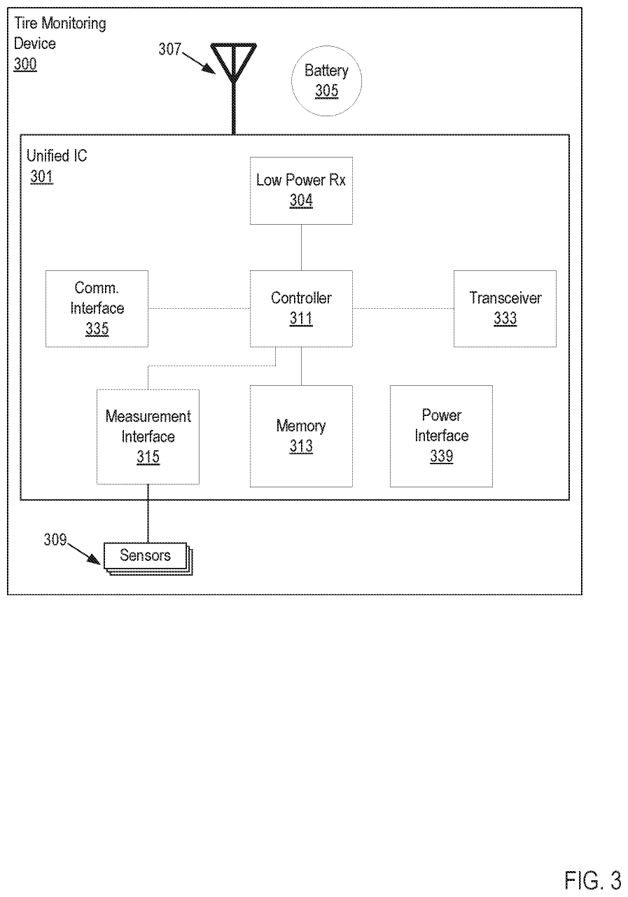

In FIG. 2, the tire monitoring IC (201) and the communications IC (203) are illustrated as separate integrated circuits. This has the advantage of making the tire monitoring sensor (200) compatible with standalone tire monitoring circuitry, such that the standalone tire monitoring circuitry may be reconfigured to operate in conjunction with the communication IC (203) and low power receiver (204). However, it is also contemplated that the respective functions of the tire monitoring IC (201) and the communications IC (203) may be unified in a single integrated circuit, thereby eliminating the redundant implementation of certain hardware resources, as will be explained in detail with respect to FIG. 3.

For further explanation, FIG. 3 sets forth a diagram of an example implementation of a tire monitoring sensor (300) for vehicle sensor learning using a low power wake-up receiver according to embodiments of the present disclosure. The example tire monitoring sensor (300) of FIG. 3 includes a unified integrated circuit (IC) (301), a battery (305), an antenna (307), and one or more sensors (309) such as a pressure sensor (e.g. a piezo resistive transducer or a piezoelectric or capacitance based pressure sensor for measuring air pressure in a respective tire), a temperature sensor, and a motion sensor (e.g., an accelerometer responsive to acceleration and/or changes in acceleration experienced during rotation of a respective tire).

The unified IC (301) includes a controller (311), which may comprise a suitably programmed processor, for example a dedicated microprocessor or a microcontroller, or other programmable processing device. Standard components such as random-access memory (RAM), an analog-to-digital converter (ADC), an input/output (I/O) interface, a clock, and a central microprocessor (all not shown) may be provided, the components typically being integrated onto a single chip. Alternatively, or additionally, a custom microcontroller such as an Application Specific Integrated Circuit (ASIC), a digital signal processor (DSP), a programmable logic array (PLA) such as a field programmable gate array (FPGA), or other data computation unit in accordance with the present disclosure may be used. The controller (311) may be configured to collect sensor readings related to tire operating conditions from the sensors (309) (e.g., tire pressure) and transmit sensor data to the VCS. The unified controller (311) may be further configure do detect a wake-up signal received by a low power receiver and broadcast, in response to the wake-up signal, a sensor ID via a transceiver (e.g., a Bluetooth transceiver).

The unified IC (301) also includes a measurement interface (315). The sensors (309) may be connected to the measurement interface (315) for measuring characteristics of the tire using signals received from the sensors (309) and for providing corresponding information to the controller (311). The measurement interface (315) may comprise hardware (i.e., electronic circuitry) for performing measurement tasks, including but not limited to at least one amplifier, at least one filter and, and an ADC (not shown) for measuring values such as tire pressure, temperature, and acceleration. The unified IC (301) may also include a memory (313). The sensor readings and data collected from the sensors (309) may be stored in the memory (313). The memory (313) may be a non-volatile memory such as flash memory. A unique identifier that may be used as a sensor ID may also be stored in the memory (313) or programmed into the controller (311).

The unified IC (301) also includes a transceiver (333) coupled to the controller (311). The transceiver (333) may be configured for bidirectional wireless communication. For example, once the transceiver is configured for communication with the VCS, the transceiver may be used to transmit tire parameters (e.g., tire pressure, tire temperature data, accelerometric data) to the VCS and receive vehicle parameters and configuration parameters from the VCS. The transceiver (333) may be configured to communicate a sensor ID to a remote device, such as an activation tool or activation station in an assembly line. The transceiver (333) may be configured for operation within a particular RF band, such as the ISM 2.4 GHz band with a frequency range of 2.4 GHz to 2.5 GHz that includes an unlicensed portion of the RF spectrum. In a particular embodiment, the transceiver (333) may be a Bluetooth protocol transceiver, such as a Bluetooth Low Energy transceiver or a Bluetooth Smart transceiver, operating between 2.4 GHz and 2.4835 GHz. In other embodiments, the transceiver (333) may be other types of low power radio frequency communication technology that is intended to conserve energy consumed in the tire monitoring sensor.

The unified IC (301) may also include the low power receiver (304). The low power receiver (304) may be an RF receiver configured to receive an activation signal (also referred to as a wake-up signal) from a remote device such as a handheld activation tool, vehicle-mounted activation tool, or an activation station in an assembly line. The low power receiver (304) may be a low power device in that it draws less than 1 μA of current. In a particular embodiment, the low power receiver (304) draws less 200 nA of current. It will be appreciated by those of skill in the art that the power consumed by the low power receiver (304) is several orders of magnitude lower than the power consumed by the transceiver (333), even if the transceiver (333) is in a receive-only state, low rate duty cycle state, or other dormant state.

The low power receiver (304) may be configured for communication within the same RF band as the transceiver (333) (i.e., the ISM 2.4 GHz band with a frequency range of 2.4 GHz to 2.5 GHz). As such, remote devices, such as the activation tool or the activation station in an assembly line, may communicate an activation signal to the low power receiver (304) using the same transceiver used by the remote device to communicate with other sensors and devices (e.g., other Bluetooth protocol sensors). Therefore, a separate activation tool, such as an LF coil exciter, is not required to activate the tire monitoring sensor (300). Further, the implementation of the tire monitoring/measurement circuitry, communication circuitry, and low power receiver in a single integrated circuit, in addition to the removal of a LF coil, further reduces the size of the electronic components of the tire monitoring sensor and integrates the components into a standalone package.

The unified IC (301) may also include a communications interface (335) for organizing data according to communications protocols for transmitting and receiving data via the transceiver (335). For example, the communications interface (335) may encapsulate data in packets. The unified IC (301) may also include a power interface (339) for supplying power received from the battery (305) to the various components of the unified IC (301).

The battery (305) may provide power to a power interface (339) of the unified IC (301) and other components of the tire monitoring sensor (300). However, it also contemplated that other power sources may be used (e.g., thermoelectric or piezoelectric generators, electromagnetic induction device, and/or other energy harvesters) instead of or in addition to the battery (305).

The antenna (307) may be used by the tire monitoring sensor (300) to transmit and receive RF signals. The antenna (307) may be coupled to the transceiver (333) for transmitting and receiving RF signals. The antenna (307) may also couple to the low power receiver (304) for receiving an RF activation signal.

In a particular embodiment, the tire monitoring sensor (300) may be installed on the vehicle at a vehicle dealership, a tire dealership, a repair shop, or a vehicle OEM assembly line. At the time of installation, the tire monitoring sensor may be in a standby state, in that the low power receiver (304) receives power but the transceiver (333) and other components do not receive power. Power may be provided to the low power receiver (304) continuously or cycled at a particular interval. Prior to installation, the tire monitoring sensor (300) may be received in an OFF state such that no component receives power, and installation personnel may turn the tire monitoring sensor (300) to an ON state such that the low power receiver (304) begins receiving power. Upon installation, an activation tool such as a handheld device, vehicle-mounted device, or assembly line activation station may transmit an activation signal to the tire monitoring sensor (300). The activation signal may be transmitted with a frequency within the 2.4 GHz band. The activation signal may be received by the low power receiver (304), which provides a wake signal to the unified IC (301). The unified IC (301) may transmit a response signal encoding a sensor ID to the activation tool via the transceiver (333). The response signal may also be transmitted using the 2.4 GHz band. As such, the activation tool may transmit the activation signal and receive the response signal using a transceiver configured for communication within the 2.4 to 2.5 GHz portion of the RF spectrum (e.g., a Bluetooth transceiver). The activation tool may then associate the sensor ID with a tire location on the vehicle, and subsequently provide sensor ID and tire location to the VCS (directly or indirectly). Subsequent to association of the sensor ID with a location on the vehicle, the transceiver may also be used to transmit tire monitoring information such as pressure data, temperature data, battery data, and/or accelerometric data. For example, after the VCS has learned the association between the sensor ID of a tire monitoring sensor and its location, an activation tool on the vehicle may transmit a wake-up signal to the low power receiver (603), which causes the tire monitoring sensor (601) to transition into a wake state and begin transmitting data such as pressure data, temperature data, battery data, and/or accelerometric data.

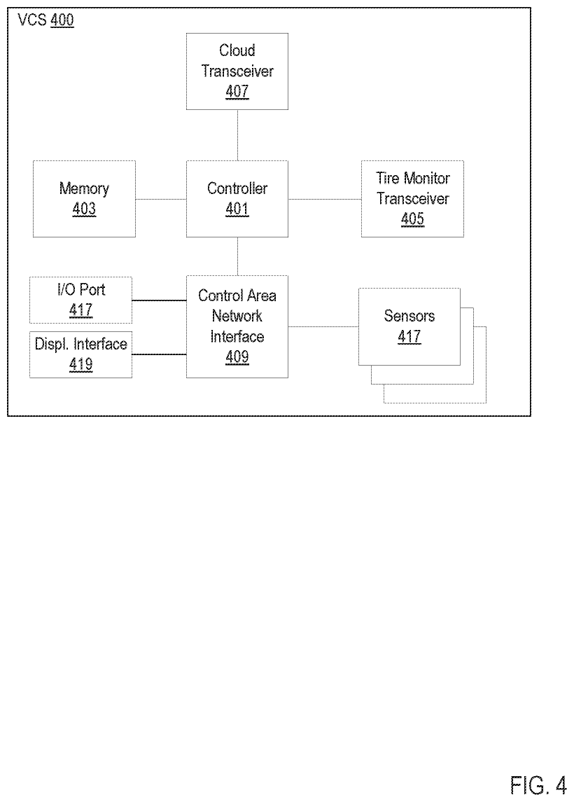

For further explanation, FIG. 4 sets forth a diagram of an exemplary vehicle control system (VCS) (400) for vehicle sensor learning using a low power wake-up receiver according to embodiments of the present disclosure. The VCS (400) includes a VCS controller (401) coupled to a memory (403). The VCS controller (401) may be configured to obtain sensor readings related to vehicle operating conditions, as well as data from sources external to the vehicle (e.g., the tool (113) of FIG. 1), and provide configuration parameters to a tire monitoring sensor (e.g. the tire monitoring sensor (200) of FIG. 2 or the tire monitoring sensor (300) of FIG. 3). The VCS controller (401) may include or implement a microcontroller, an Application Specific Integrated Circuit (ASIC), a digital signal processor (DSP), a programmable logic array (PLA) such as a field programmable gate array (FPGA), or other data computation unit in accordance with the present disclosure. The sensor readings and data, as well as tire feature data received from the TMS, may be stored in the memory (403). The memory (403) may be a non-volatile memory such as flash memory. For example, the VCS (400) may obtain vehicle operating condition data such as sensor readings from sensors on-board the vehicle and/or vehicle tires.

For bidirectional wireless communication with a tire monitoring sensor, the VCS (400) may include a transceiver (405) coupled to the VCS controller (401). In one embodiment, the transceiver (405) may be a Bluetooth Low Energy transmitter-receiver. In other embodiments, the transceiver (405) may be other types of low power radio frequency communication technology that is intended to conserve energy consumed in the TMS. In a particular embodiment, the transceiver (405) may be a TPMS or tire mounted transceiver communicatively coupled to a tire monitoring sensor that is a TPMS sensor or a tire mounted sensor. The VCS (400) may further include a cloud transceiver (407) for cellular terrestrial communication, satellite communication, or both. For example, the cloud transceiver (407) may be used to communicate tire parameters (e.g., tire pressure) to a remote server. The cloud transceiver (407) may also be used to receive configuration parameters for the vehicle.

The VCS (400) may further comprise a controller area network (CAN) interface (409) for communicatively coupling vehicle sensors (417) and devices to the controller (401), such as wheel speed sensors, a yaw rate sensor, an inclination sensor, and other sensors, to the controller (401). Of particular relevance to the present disclosure, the CAN interface (409) couples an I/O port (417) to the controller (401). The I/O port (417) may be used to receive tire monitoring sensor location configuration data. For example, an external tool, server, or assembly line station may connect to the input port to input the sensor ID and vehicle tire location for each tire monitoring sensor of the vehicle. The CAN interface (409) may also couple a display interface (419) to the controller (401). The display interface (419) may be used to output indicia of tire parameters to a dashboard or display of the vehicle. For example, the output port may be used to output tire pressure indicia to the dashboard or display to warn the driver about low tire pressure detected in a tire by a tire monitoring sensor.

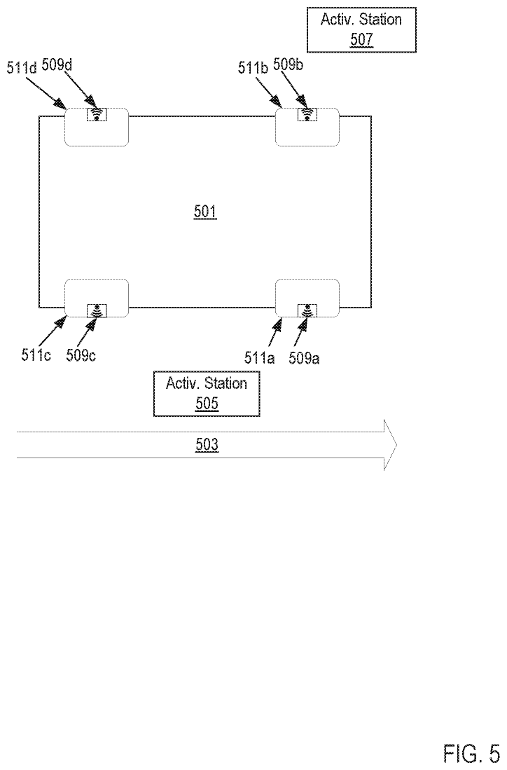

For further explanation, FIG. 5 sets forth a block diagram of an exemplary system (500) for vehicle sensor learning using a low power wake-up receiver according to embodiments of the present disclosure that includes vehicle (501) in an assembly line (503) having at least two activations stations (505, 507) that may be staggered on opposite sides of the vehicle (501) as it travels, for example, left to right along the assembly line (503). A tire monitoring sensor (509a-d) may be respectively located on each wheel/tire (511a-d) of the vehicle (501). The sensitivity of the low power receiver (204, 304) in each tire monitoring sensor (509a-d) may be tuned such that when the tire monitoring sensor (509a) for the Right Front wheel is activated, none of the other tire monitoring sensors (509b-d) will be activated. In the illustrated example, the next tire monitoring sensor to be activated is the tire monitoring sensor (509b) on the Left Front wheel, followed by the tire monitoring sensor (509c) on the Right Rear wheel, and finally the tire monitoring sensor (509d) on the Left Rear wheel. During the time that the vehicle (501) is passing the activation stations (505, 507), the tire monitoring sensors (509a-d) may be activated via the low power receivers (204, 304) and the sensor ID codes may be extracted from the data transmitted by the transceivers (233, 333). An assembly line controller (511) may collect the sensor IDs and associate them with their relative location on the vehicle. These sensor ID codes and their locations may then be programmed into the VCS at some further point in the assembly process via an I/O port of the VCS CAN interface. Similarly, the low power receiver of the tire monitoring sensor can also be used for activation at dealerships or for the purposes of vehicle repair. The activation stations (505, 507) may transmit the activation signal and receive the sensor ID response signal using a single 2.4 GHz band interface, rather than using a separate interface to activate a LF coil.

The sensitivity of the activation range of the low power receiver (204, 304) may be digitally tuned to avoid activating all sensors that are within a range of the activating device. However other methods of tuning that are known in the art could also be used. When the sensitivity of the low power receiver is tuned appropriately, the activation range of the low power receiver may be similar to that of a conventional LF coil.

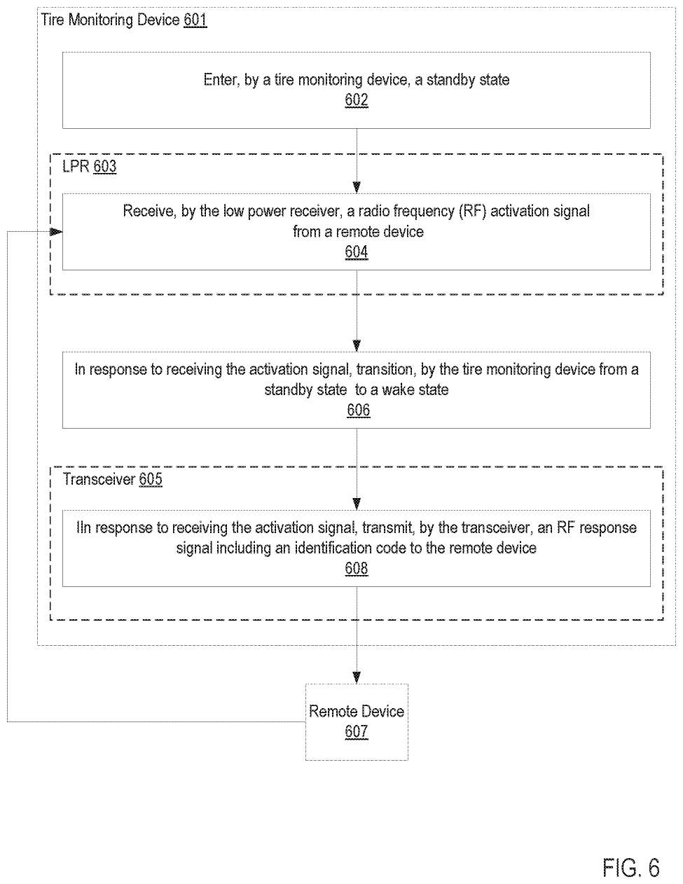

For further explanation, FIG. 6 sets forth a flow chart illustrating an exemplary method for vehicle sensor learning using a low power wake-up receiver according to embodiments of the present disclosure that includes entering (602), by a tire monitoring sensor (601), a standby state, wherein the tire monitoring sensor comprises a low power receiver (603) and a transceiver (605). Entering, by the tire monitoring sensor (601), the standby state may be carried out by placing the tire monitoring sensor (601) (e.g., the tire monitoring sensor (105) of FIG. 1A and FIG. 1B, the tire monitoring sensor (200) of FIG. 2 or the tire monitoring sensor (300) of FIG. 3) into a standby or sleep state in which power is supplied to the low power receiver (603) (e.g., the low power receiver (204) of FIG. 2 or the low power receiver (304) of FIG. 3) but is not supplied to the transceiver (605) (e.g., the transceiver receiver (233) of FIG. 2 or the transceiver (333) of FIG. 3).

For example, the transceiver (605) may be a Bluetooth protocol transceiver such as a Bluetooth Low Energy or Bluetooth Smart transceiver. Even when the transceiver (605) is in listen-only state, the transceiver (605) consumes more power than the low power receiver (603) by multiple orders of magnitude. For example, transceiver may consume 1 mA or greater even when in a listen-only, low rate duty cycle, or other dormant state; whereas, the low power receiver (603) may consume less than 200 nA. While in the standby state, the low power receiver (603) may receive continuous power or power may be cycled to the low power receiver (603) at an interval programmed into the tire monitoring sensor (601). In one example, the tire monitoring sensor (601) may be in an OFF state where no power is provided to any component of the tire monitoring sensor (601) when it leaves the tire monitoring sensor OEM, and the tire monitoring sensor (601) may be placed in the standby state when it begins an installation process at a vehicle OEM assembly line or vehicle dealership such that the low power receiver is supplied with power for receiving the activation signal.

The method of FIG. 6 also includes receiving (604), by the low power receiver (603), a radio frequency (RF) activation signal from a remote device (607). Receiving (604), by the low power receiver (603), the radio frequency (RF) activation signal from the remote device (607) may be carried out by the remote device (e.g., the activation stations (507, 509) of FIG. 5 or a handheld activation tool) transmitting an activation signal that is received by the low power receiver (603) while the tire monitoring sensor is in a standby or sleep state. The activation signal may be transmitted by a transceiver of the remote device (607) at a frequency within the ISM 2.4 GHz band. Thus, the RF band of the activation signal is substantially higher, and therefore different, than an RF band used to excite a low frequency coil. The sensitivity of the low power receiver (603) may be tuned such that the low power receiver (603) will detect the activation signal only when it is within a relatively close range of the remote device (607). The precise frequency channel of the low power receiver (603) to receive the activation signal may be programmed into the low power receiver (603) and known by the remote device (607).

The method of FIG. 6 also includes in response to receiving the activation signal, transitioning (606), by the tire monitoring sensor (601), from the standby state to a wake state. Transitioning (606), by the tire monitoring sensor (601) in response to receiving the activation signal, to the wake state may be carried out by a controller (e.g., the controller (231) of FIG. 2 or the controller (311) of FIG. 3) detecting the activation signal received on the low power receiver (603) and activating electronic components of the tire monitoring sensor (601) such that the controller of the tire monitoring sensor may control the transceiver (605) to transmit a sensor ID stored on or programmed into the tire monitoring sensor (601). Activating electronic components may be carried out by directing power to be supplied to the electronic components, including but not limited to the transceiver (605) as well as other components described with reference to FIGS. 2 and 3.

The method of FIG. 6 also includes in response to receiving the activation signal, transmitting (608), by the transceiver (605), an RF response signal including an identification code to the remote device (607). Transmitting (608), by the transceiver (605), the RF response signal including the identification code to the remote device (607) may be carried out by the transceiver (605) broadcasting, advertising, or otherwise sending a signal indicating the sensor ID of the tire monitoring sensor (601). In an embodiment, the response signal is transmitted in the same RF band used by the remote device (607) to transmit the activation signal. For example, the transceiver (605) may transmit a packet of information containing the unique identifier or name of the tire monitoring sensor (601) that is programmed into the tire monitoring sensor (601) by the OEM of the tire monitoring sensor (601), or transmit a packet over a channel advertised with the sensor ID. In a particular embodiment, the transceiver (605) is a Bluetooth Low Energy transceiver and the RF band is the ISM 2.4 GHz band. The response signal including the identification code may be received by the remote device (607), which may associate the identification code with a tire/wheel location on the vehicle. Subsequent to association of the sensor ID with a location on the vehicle, the transceiver may also be used to transmit tire monitoring information such as pressure data, temperature data, battery data, and/or accelerometric data. For example, after the VCS has learned the association between the sensor ID of a tire monitoring sensor and its location, an activation tool on the vehicle may transmit a wake-up signal to the low power receiver (603), which causes the tire monitoring sensor (601) to transition into a wake state and begin transmitting data such as pressure data, temperature data, battery data, and/or accelerometric data.

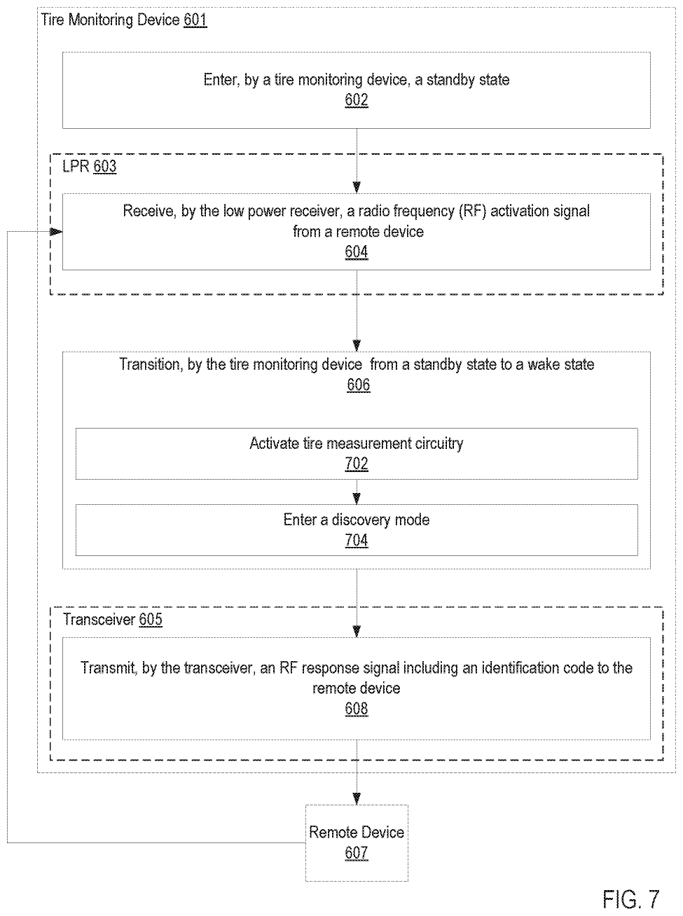

For further explanation, FIG. 7 sets forth a flow chart illustrating another exemplary method for vehicle sensor learning using a low power wake-up receiver according to embodiments of the present disclosure. Like the exemplary method of FIG. 6, the method of FIG. 7 also includes entering (602), by a tire monitoring sensor (601), a standby state, wherein the tire monitoring sensor comprises a low power receiver (603) and a transceiver (605); receiving (604), by the low power receiver (603), a radio frequency (RF) activation signal from a remote device (607); transitioning (606), by the tire monitoring sensor (601) in response to receiving the activation signal, to a wake state; and transmitting (608), by the transceiver (605), an RF response signal including the identification code to the remote device (607).

The method of FIG. 7 differs from the method of FIG. 6 in that transitioning (606), by the tire monitoring sensor (601) in response to receiving the activation signal, to a wake state includes activating (702) tire measurement circuitry. Activating (702) tire measurement circuitry may be carried out by the controller (e.g., the controller (231) of FIG. 2 or the controller (311) of FIG. 3) directing power to be supplied to measurement components such as measurement interfaces (e.g., the measurement (215) of FIG. 2 or the measurement interface (315) of FIG. 3) that include electronic circuitry for performing measurement tasks, such as an amplifier, a filter, and an ADC (all not shown) for measuring values such as tire pressure, temperature, and acceleration. That is, the controller initiates the periodic sampling of data received from tire sensors.

The method of FIG. 7 also differs from the method of FIG. 6 in that transitioning (606), by the tire monitoring sensor (601) in response to receiving the activation signal, to a wake state includes entering (704) a discovery mode. Entering (704) a discovery mode may be carried out by the controller (e.g., the controller (231) of FIG. 2 or the controller (311) of FIG. 3) initiating a discovery protocol of the tire monitoring sensor (601) such as a discovery mode that advertises or broadcasts an address (e.g., a 48 bit address), device name, or other identifying information. For example, entering (704) a discovery mode may include making the tire monitoring sensor (601) available for pairing with the VCS.

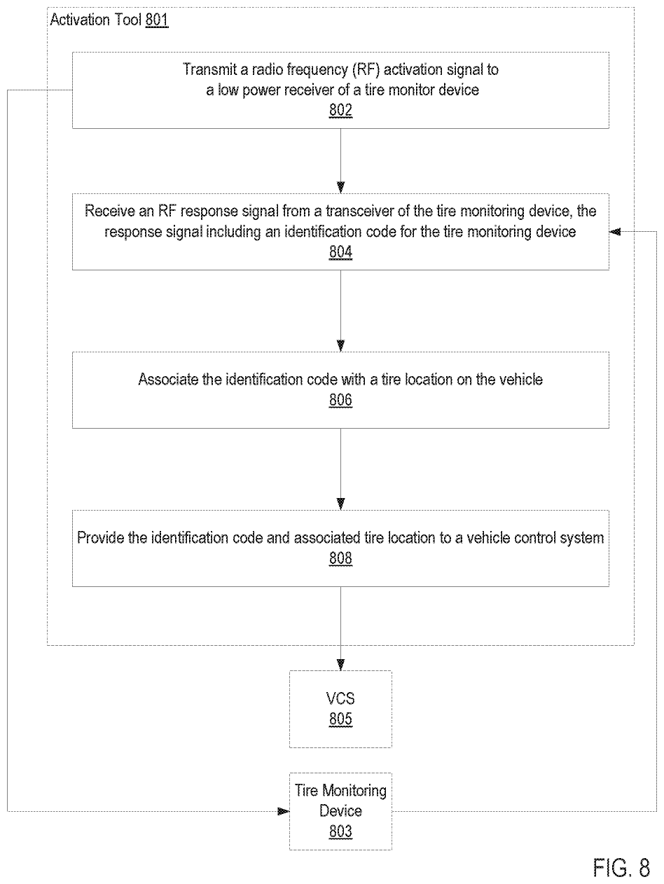

For further explanation, FIG. 8 sets forth a flow chart illustrating an exemplary method for vehicle sensor learning using a low power wake-up receiver according to embodiments of the present disclosure that includes transmitting (802) a radio frequency (RF) activation signal to a low power receiver of a tire monitoring sensor (803). Transmitting (802) a radio frequency (RF) activation signal to a low power receiver of a tire monitoring sensor (803) may be carried out by an activation tool (801) (e.g., the activation stations (507, 509) of FIG. 5 or a handheld activation tool) transmitting an activation signal that is received by a low power receiver (e.g., the low power receiver (204) of FIG. 2 or the low power receiver (304) of FIG. 3) of a tire monitoring sensor (803) (e.g., the tire monitoring sensor (200) of FIG. 2 or the tire monitoring sensor (300) of FIG. 3) while the tire monitoring sensor (803) is in a standby or sleep state. The activation signal may be transmitted by a transceiver of the activation tool (801) at a frequency ranging from 2.4 GHz to 2.5 GHz. The sensitivity of the low power receiver may be tuned such that the low power receiver (603) will detect the activation signal only when it is within a relatively close range of the activation tool (801). The precise frequency channel of the low power receiver (603) to receive the activation signal may be programmed into the low power receiver (603) and known by the activation tool (801).

The method of FIG. 8 also includes in response to transmitting the RF activation signal, receiving (804) an RF response signal from a transceiver of the tire monitoring sensor (803), where the response signal includes an identification code for the tire monitoring sensor (803). Receiving (804) an RF response signal from a transceiver of the tire monitoring sensor (803) may be carried out by detecting signal that broadcasts or advertises an identification code of the tire monitoring sensor. The identification code may be included in a packet of data. For example, the transceiver of the tire monitoring sensor (803) may transmit a signal including a packet of information containing the unique identifier or name of the tire monitoring sensor (803) that is programmed into the tire monitoring sensor (803) by the OEM of the tire monitoring sensor (803). The response signal may be transmitted by the tire monitoring sensor (803) at a frequency ranging from 2.4 GHz to 2.5 GHz. In a particular embodiment, the transceiver of the tire monitoring sensor (803) is a Bluetooth transceiver.

The method of FIG. 8 also includes associating (806) the identification code with a tire location on the vehicle. Associating (806) the identification code with a tire location on the vehicle may be carried out by the activation tool (801) storing the sensor ID obtained from the tire monitoring sensor (803) and the location of the tire monitoring sensor (803) relative to the vehicle in a data structure stored in a memory device (not shown). For example, the sensor ID “12345” may be associated with “Left Front” in a data structure for vehicle. A controller (e.g., the controller (511) of FIG. 5 or a handheld activation tool controller (not shown)) may record the associations between the sensor IDs and the relative vehicle locations in the data structure.

The method of FIG. 8 also includes providing (808) the identification code and associated tire location to a vehicle control system (805). Providing (808) the identification code and associated tire location to a vehicle control system (805) (e.g., the VCS (400) of FIG. 4) may be carried out by the activation tool (801) connecting to an input port (e.g., the input port (405) of FIG. 4) of a CAN interface of the VCS and downloading the sensor IDs and corresponding location to the VCS (805). For example, the sensor IDs and location may be obtained from the data structure storing the associations. The sensor IDs and location may be input to the VCS at a point in the assembly line (e.g., assembly line (501) of FIG. 5), at a vehicle dealership, or in a repair shop.

In view of the explanations set forth above, readers will recognize that the benefits of vehicle sensor learning using a low power wake-up receiver according to embodiments of the present disclosure include, but are not limited to:
The replacement of the low frequency coil, which is typically implemented on a printed circuit board, with a low power receiver reduces the size of the electronic components used to implement a tire monitoring sensor such as a tire pressure monitoring system sensor or a tire mounted sensor.
The elimination of the low frequency coil further allows the electronic components of the tire monitoring sensor (i.e., the tire monitoring circuitry, communication circuitry, and the low power receiver used for activating the tire monitoring sensor) to be integrated into a standalone package.
The use of a low power receiver that operates in the same frequency spectrum as the transceiver of the tire monitoring sensor allows for a single interface to be used in activating and communicating with the tire monitoring sensor.

Exemplary embodiments of the present invention are described largely in the context of a fully functional computer system for vehicle sensor learning using a low power wake-up receiver. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, an apparatus, a device, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or other devices to cause a series of operational steps to be performed on the computer, other programmable apparatuses or other devices to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, apparatuses, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of vehicle sensor learning using a low power wake-up receiver in tire monitoring sensor, the method comprising:
receiving from a remote device, by a low power receiver of a tire monitoring device, a radio frequency (RF) activation signal; and
in response to receiving the activation signal:
transitioning, by the tire monitoring sensor, from a standby state to a wake state; and
transmitting, by a transceiver of the tire monitoring device, an RF response signal including an identification code to the remote device.

2. The method of claim 1, wherein, while in the standby state, continuous power is provided to the low power receiver and no power is provided to the transceiver.

3. The method of claim 1 wherein, while in the standby state, power is cycled to the low power receiver at a particular interval and no power is provided to the transceiver.

4. The method of claim 1, wherein current supplied to the low power receiver is than 1 microampere.

5. The method of claim 1, wherein the transceiver is a Bluetooth Low Energy transceiver.

6. The method of claim 1, wherein the RF activation signal and the RF response signal are both transmitted in a frequency band of 2.4 GHz to 2.5 GHz.

7. The method of claim 1, wherein in response to receiving the activation signal, transitioning, by the tire monitoring sensor, from the standby state to a wake state includes:
activating tire measurement circuitry; and
entering a discovery mode.

8. The method of claim 1, wherein the tire monitoring sensor is a tire pressure monitoring system (TPMS) sensor.

9. A tire monitoring sensor for vehicle sensor learning using a low power wake-up receiver, comprising:
tire monitoring circuitry communicatively coupled to one or more sensors that measure operational characteristics of a tire, wherein the tire monitoring circuitry is configured to collect data from the one or more sensors.
a low power receiver configured to receive signals in a particular radio frequency (RF) range;
a transceiver configured to send and receive signals in the particular RF range; and
control circuitry configured to:
detect, while in a standby state, an activation signal received by the low power receiver from a remote device; and
in response to receiving the activation signal:
transition the tire monitoring sensor from the standby state to a wake state; and
transmit to the remote device, a response signal that includes an identification code.

10. The tire monitoring sensor of claim 9, wherein, while in the standby state, continuous power is provided to the low power receiver and no power is provided to the transceiver.

11. The tire monitoring sensor of claim 9 wherein, while in the standby state, power is cycled to the low power receiver at a particular interval and no power is provided to the transceiver.

12. The tire monitoring sensor of claim 9, wherein current supplied to the low power receiver is than 1 microampere.

13. The tire monitoring sensor of claim 9, wherein the transceiver is a Bluetooth Low Energy transceiver.

14. The tire monitoring sensor of claim 9, wherein the RF activation signal and the RF response signal are both transmitted in a frequency range of 2.4 GHz to 2.5 GHz.

15. The tire monitoring sensor of claim 9, wherein the control circuitry is configured to transition the tire monitoring sensor to the wake state by:
activating the monitoring circuitry; and
entering a discovery mode.

16. The tire monitoring sensor of claim 9, wherein the tire monitoring sensor is a tire pressure monitoring system (TPMS) sensor.

17. A method for vehicle sensor learning using a low power wake-up receiver:
transmitting a radio frequency (RF) activation signal to a low power receiver of a tire monitoring sensor;
in response to transmitting the RF activation signal, receiving an RF response signal from a transceiver of the tire monitoring sensor, the RF response signal including an identification code for the tire monitoring sensor;
associating the identification code with a tire location on the vehicle; and
providing to a vehicle control system, the identification code and associated tire location.

18. The method of claim 17, wherein the activation signal and the response signal each have a frequency within a frequency range of 2.4 GHz to 2.5 GHz.

19. A device for vehicle sensor learning using a low power wake-up receiver, comprising:
a transceiver configured to:
transmit a radio frequency (RF) activation signal to a low power receiver of a tire monitoring sensor, and
in response to transmitting the RF activation signal, receive an RF response signal from a transceiver of the tire monitoring sensor, the response signal including an identification code for the tire monitoring sensor; and
a controller configured to:
associate the identification code with a tire location on the vehicle, and
provide the identification code and associated tire location to a vehicle control system.

20. The device of claim 19, wherein the activation signal and the response signal each have a frequency within a frequency range of 2.4 GHz to 2.5 GHz.
